(19) United States
(12) Patent Application Publication
(10) Pub. No.: US 2025/0009471 A1
(43) Pub. Date: Jan. 9, 2025

(54) MODELING A BITE ADJUSTMENT FOR AN ORTHODONTIC TREATMENT PLAN

(71) Applicants: Anton Olegovich KALININ, Moscow (RU); SDC U.S. SmilePay SPV, New York, NY (US)

(72) Inventors: ANTON OLEGOVICH KALININ, Moscow (RU); SERGEY NIKOLSKIY, Nashville, TN (US); ESTEBAN ZAMORA SBRAVATTI, Barcelona (ES)

(73) Assignee: SDC U.S. SmilePay SPV, New York, NY (US)

(21) Appl. No.: 18/710,025

(22) PCT Filed: Nov. 15, 2021
(86) PCT No.: PCT/RU2021/000503

§ 371 Date: May 14, 2024

(51) Int. Cl. A61C 7/00; G06T 7/00

(52) U.S. Cl. CPC A61C 7/002; G06T 7/0012; G06T 2207/30036

(57) ABSTRACT

Systems and methods for generating a treatment plan include a system for receiving a first series of three-dimensional (3D) representations of an upper dental arch and a lower dental arch showing a progression of teeth in the upper dental arch and lower dental arch. The system identifies a distance between a tooth from the upper dental arch and corresponding tooth from the lower dental arch and determines a movement of the upper dental arch or the lower dental arch to decrease the distance between the tooth from the upper dental arch and the corresponding tooth from the lower dental arch. The system generates a second 3D representation of the plurality of upper teeth and the plurality of lower teeth based on the determined movement to reflect the minimized distance and a visualization depicting the progression of the teeth in the upper dental arch and the lower dental arch.

### TECHNICAL FIELD

The present disclosure relates generally to the field of dental treatment, and more specifically, to systems and methods for generating a treatment plan for orthodontic treatment.

### BACKGROUND

Some patients may receive dental aligner treatment for misalignment of teeth. To provide the patient with dental aligners to treat the misalignment, a dentist typically generates a treatment plan. The treatment plan may include three-dimensional (3D) representations of the patient's teeth as they progress from their pre-treatment position (e.g., an initial position) to a target final position. In developing this treatment plan, a gap between one or more teeth may be observed throughout each stage. For example, various movements of teeth throughout the treatment plan may cause misalignment of teeth between an upper arch and lower arch of a mouth observable in the 3D representations. This may require having to adjust the 3D representations to avoid the misalignment. The treatment plan may include moving the upper and lower arches of a mouth relative to an occlusal plane (e.g., between the upper arch and lower arch) to a final position to treat the misalignment, and to provide better contacts between the upper and lower dental arch. However, manually moving the jaw relative to an occlusal axis is tedious and time-consuming. Furthermore, such manual processes are inexact and error-prone as they rely on trial and error to reach the target final position.

### SUMMARY

In one aspect, this disclosure is directed to a method. The method includes receiving, by one or more processors, a first series of three-dimensional (3D) representations of an upper dental arch and a lower dental arch, the first series of 3D representations showing a progression of teeth in the upper dental arch and lower dental arch from an initial position to a final position. The method further includes determining, by the one or more processors, for a first 3D representation of the first series of 3D representations, a distance between at least one tooth from the upper dental arch and a corresponding at least one tooth from the lower dental arch. The method further includes determining, by the one or more processors, using a transformation, a movement of at least one of the upper dental arch or the lower dental arch, to decrease the distance between the at least one tooth from the upper dental arch and the corresponding at least one tooth from the lower dental arch. The method further includes generating, by the one or more processors, a second 3D representation of the plurality of upper teeth and the plurality of lower teeth based on the determined movement to reflect the minimized distance. The method further includes generating, by the one or more processors, a visualization comprising the second 3D representation, the visualization depicting the progression of the teeth in the upper dental arch and the lower dental arch.

In another aspect, this disclosure is directed to a system. The system includes one or more processors. The system includes a server system including memory storing instructions that, when executed by the one or more processors, cause the one or more processors to receive a first series of three-dimensional (3D) representations of an upper dental arch and a lower dental arch, the first series of 3D representations showing a progression of teeth in the upper dental arch and lower dental arch from an initial position to a final position. The instructions further cause the one or more processors to determine, for a first 3D representation of the first series of 3D representations, a distance between at least one tooth from the upper dental arch and a corresponding at least one tooth from the lower dental arch. The instructions further cause the one or more processors to determine, using a transformation, a movement of at least one of the upper dental arch or the lower dental arch, to decrease the distance between the at least one tooth from the upper dental arch and the corresponding at least one tooth from the lower dental arch. The instructions further cause the one or more processors to generate a second 3D representation of the plurality of upper teeth and the plurality of lower teeth based on the determined movement to reflect the minimized distance. The instructions further cause the one or more processors to generate a visualization comprising the second 3D representation, the visualization depicting the progression of the teeth in the upper dental arch and the lower dental arch.

In yet another aspect, this disclosure is directed to a non-transitory computer readable medium that stores instructions. The instructions, when executed by one or more processors, cause the one or more processors to receive a first series of three-dimensional (3D) representations of an upper dental arch and a lower dental arch, the first series of 3D representations showing a progression of teeth in the upper dental arch and lower dental arch from an initial position to a final position. The instructions further cause the one or more processors to determine, for a first 3D representation of the first series of 3D representations, a distance between at least one tooth from the upper dental arch and a corresponding at least one tooth from the lower dental arch. The instructions further cause the one or more processors to determine, using a transformation, a movement of at least one of the upper dental arch or the lower dental arch, to decrease the distance between the at least one tooth from the upper dental arch and the corresponding at least one tooth from the lower dental arch. The instructions further cause the one or more processors to generate a second 3D representation of the plurality of upper teeth and the plurality of lower teeth based on the determined movement to reflect the minimized distance. The instructions further cause the one or more processors to generate a visualization comprising the second 3D representation, the visualization depicting the progression of the teeth in the upper dental arch and the lower dental arch.

Various other embodiments and aspects of the disclosure will become apparent based on the drawings and detailed description of the following disclosure.

### BRIEF DESCRIPTION OF THE DRAWINGS

FIG. 1 shows a system for orthodontic treatment, according to an illustrative embodiment.

FIG. 2 shows a process flow of generating a treatment plan, according to an illustrative embodiment.

FIG. 3 shows a top-down simplified view of a model of a dentition, according to an illustrative embodiment.

FIG. 4 shows a perspective view of a three-dimensional model of the dentition of FIG. 3, according to an illustrative embodiment.

FIG. 5 shows a trace of a gingiva-tooth interface on the model shown in FIG. 3, according to an illustrative embodiment.

FIG. 6 shows selection of teeth in a tooth model generated from the model shown in FIG. 5, according to an illustrative embodiment.

FIG. 7 shows a segmented tooth model of an initial position of the dentition shown in FIG. 3, according to an illustrative embodiment.

FIG. 8 shows a target final position of the dentition from the initial position of the dentition shown in FIG. 7, according to an illustrative embodiment.

FIG. 9 shows a series of stages of the dentition from the initial position shown in FIG. 7 to the target final position shown in FIG. 8, according to an illustrative embodiment.

FIG. 10 shows a tooth model of an initial position and target final position of an upper and lower dentition, according to an illustrative embodiment.

FIG. 11 shows a user interface showing a 3D model of an upper and lower dentition, according to an illustrative embodiment.

FIG. 12A through 12H show movement of 3D representations of teeth in the 3D model of FIG. 11 through various stages, according to an illustrative embodiment.

FIG. 13 is a flowchart showing a method for modeling a bite adjustment for an orthodontic treatment plan, according to an illustrative embodiment.

### DETAILED DESCRIPTION

The present disclosure is directed to systems and methods for modeling a bite adjustment (generating a virtual bite jump) for an orthodontic treatment plan. The systems and methods described herein may generate automatic optimization and adjustment of an upper arch (e.g., upper teeth) and/or a lower arch (e.g., lower teeth) of a mouth to provide an optimized bite alignment between the upper arch and the lower arch. The systems and methods described herein may implement different processes for determining automatic optimization of bite alignment. For example, the system and methods described herein may determine an optimized bite alignment relative to an occlusal plane, and generate or otherwise output a three-dimensional (3D) model of a transformation of the upper and/or lower arches. The transformation may include moving the upper and/or lower dental arches to provide an optimal contact between one or more upper teeth and one or more lower teeth of each respective dental arch. The system and methods described herein may determine a transformation that provides a densest, distributed contact between the upper and lower teeth relative to the occlusal plane, with the contact being distributed along the dental arch.

The systems and methods described herein may determine and generate one or more stages for teeth movement trajectory (e.g., transformation). The systems and methods described herein may iteratively generate 3D representations of various stages for the transformations until an optimized bite alignment between an upper and lower arch is visualized. The systems and methods described herein may determine an optimized bite alignment by calculating a distance between one or more teeth of the upper and lower arches. For example, the systems and methods described herein may determine a distance between a surface of one or more upper teeth of the upper arch and one or more lower teeth of the lower arch aligned with each other relative to the occlusal plane. The systems and methods described herein may iteratively generate one or more 3D representations corresponding to each movement of the upper and lower arches and display the one or more 3D representations on a user interface.

The systems and methods described herein may have many benefits over existing treatment planning systems. For example, by identifying and determining movements of the upper and lower arches using a transformation of the arches based on 3D data of a patient's dental arch to minimize a distance between the upper and lower arches, the systems and methods described herein may provide a visual of an optimal bite registration and contact in comparison to manual treatment planning techniques. Furthermore, since some treatment plans are generated manually, such treatment plans are often derived based on subjective data on a case-by-case and practitioner-by-practitioner basis. On the other hand, the systems and methods described herein enable repeatable and accurate treatment outcomes that are not prone to the subjectivity of a practitioner. Specifically, the computer-based systems and methods described herein are rooted in computer analysis of 3D data of the patient's dental arch including determination of transformations for the upper and/or lower dental arches, which would not be used in generating treatment plans manually as such analysis would not be capable of being performed by the human mind. Additionally, since the systems and methods described herein describe analyzing the 3D data of the patient's dental arch for determining movement of the upper and/or lower dental arches by using specific computer-implemented rules and processes, such as the transformation of the upper and/or lower dental arches, the systems and methods set forth herein are more precise and more efficient than traditional manual treatment planning systems which cannot produce the same level of immediate visualization, accuracy, and meticulousness as the computer-based treatment plan described herein. Various other technical benefits and advantages are described in greater detail below.

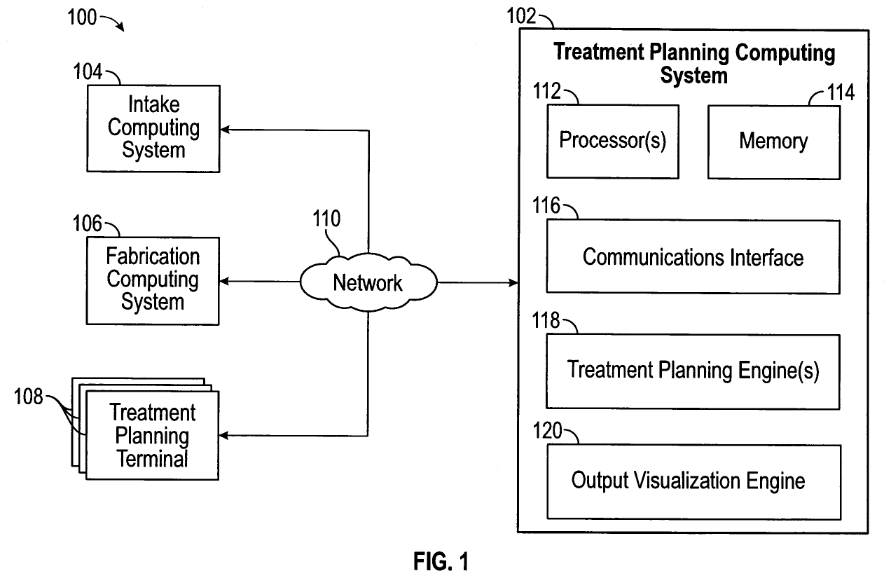

Referring to FIG. 1, a system 100 for orthodontic treatment is shown, according to an illustrative embodiment. As shown in FIG. 1, the system 100 includes a treatment planning computing system 102 communicably coupled to an intake computing system 104, a fabrication computing system 106, and one or more treatment planning terminals 108. In some embodiments, the treatment planning computing system 102 may be or may include one or more servers which are communicably coupled to a plurality of computing devices. In some embodiments, the treatment planning computing system 102 may include a plurality of servers, which may be located at a common location (e.g., a server bank) or may be distributed across a plurality of locations. The treatment planning computing system 102 may be communicably coupled to the intake computing system 104, fabrication computing system 106, and/or treatment planning terminals 108 via a communications link or network 110 (which may be or include various network connections configured to communicate, transmit, receive, or otherwise exchange data between addresses corresponding to the computing systems 102, 104, 106). The network 110 may be a Local Area Network (LAN), a Wide Area Network (WAN), a Wireless Local Area Network (WLAN), an Internet Area Network (IAN) or cloud-based network, etc. The network 110 may facilitate communication between the respective components of the system 100, as described in greater detail below.

The computing systems 102, 104, 106 include one or more processing circuits, which may include processor(s) 112 and memory 114. The processor(s) 112 may be a general purpose or specific purpose processor, an application specific integrated circuit (ASIC), one or more field programmable gate arrays (FPGAs), a group of processing components, or other suitable processing components. The processor(s) 112 may be configured to execute computer code or instructions stored in memory 114 or received from other computer readable media (e.g., CDROM, network storage, a remote server, etc.) to perform one or more of the processes described herein. The memory 114 may include one or more data storage devices (e.g., memory units, memory devices, computer-readable storage media, etc.) configured to store data, computer code, executable instructions, or other forms of computer-readable information. The memory 114 may include random access memory (RAM), read-only memory (ROM), hard drive storage, temporary storage, non-volatile memory, flash memory, optical memory, or any other suitable memory for storing software objects and/or computer instructions. The memory 114 may include database components, object code components, script components, or any other type of information structure for supporting the various activities and information structures described in the present disclosure. The memory 114 may be communicably connected to the processor 112 via the processing circuit, and may include computer code for executing (e.g., by processor(s) 112) one or more of the processes described herein.

The treatment planning computing system 102 is shown to include a communications interface 116. The communications interface 116 can be or can include components configured to transmit and/or receive data from one or more remote sources (such as the computing devices, components, systems, and/or terminals described herein). In some embodiments, each of the servers, systems, terminals, and/or computing devices may include a respective communications interface 116 which permit exchange of data between the respective components of the system 100. As such, each of the respective communications interfaces 116 may permit or otherwise enable data to be exchanged between the respective computing systems 102, 104, 106. In some implementations, communications device(s) may access the network 110 to exchange data with various other communications device(s) via cellular access, a modem, broadband, Wi-Fi, satellite access, etc. via the communications interfaces 116.

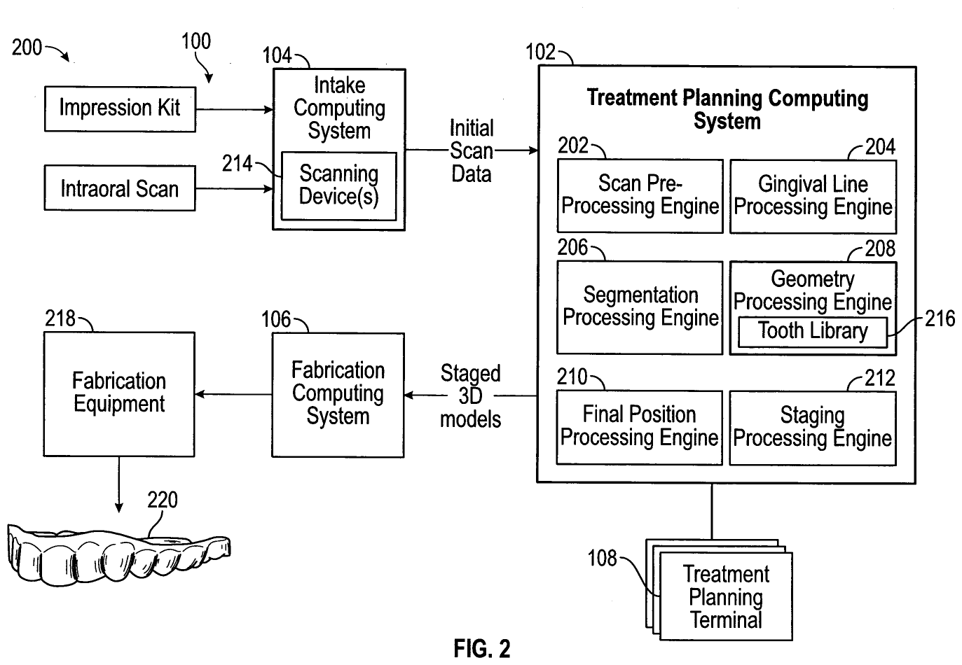

Referring now to FIG. 1 and FIG. 2, the treatment planning computing system 102 is shown to include one or more treatment planning engines 118. Specifically, FIG. 2 shows a treatment planning process flow 200 which may be implemented by the system 100 shown in FIG. 2, according to an illustrative embodiment. The treatment planning engine(s) 118 may be any device(s), component(s), circuit(s), or other combination of hardware components designed or implemented to receive inputs for and/or automatically generate a treatment plan from an initial three-dimensional (3D) model of a dentition. In some embodiments, the treatment planning engine(s) 118 may be instructions stored in memory 114 which are executable by the processor(s) 112. In some embodiments, the treatment planning engine(s) 118 may be stored at the treatment planning computing system 102 and accessible via a respective treatment planning terminal 108. As shown in FIG. 2, the treatment planning computing system 102 may include a scan pre-processing engine 202, a gingival line processing engine 204, a segmentation processing engine 206, a geometry processing engine 208, a final position processing engine 210, and a staging processing engine 212. While these engines 202-212 are shown in FIG. 2, it is noted that the system 100 may include any number of treatment planning engines 118, including additional engines which may be incorporated into, supplement, or replace one or more of the engines shown in FIG. 2.

Referring to FIG. 1, the treatment planning computing system 102 is shown to include an output visualization engine 120. The output visualization engine 120 can be or can include any device(s), component(s), circuit(s), or other combination of hardware components designed or implemented to output or otherwise provide a rendering of the treatment plan from the one or more engines shown in FIG. 2. In some embodiments, the output visualization engine 120 may be instructions stored in memory 114 which are executable by the processor(s) 112. In some embodiments, the output visualization engine 120 may be stored at the treatment planning computing system 102 and accessible via a respective treatment planning terminal 108.

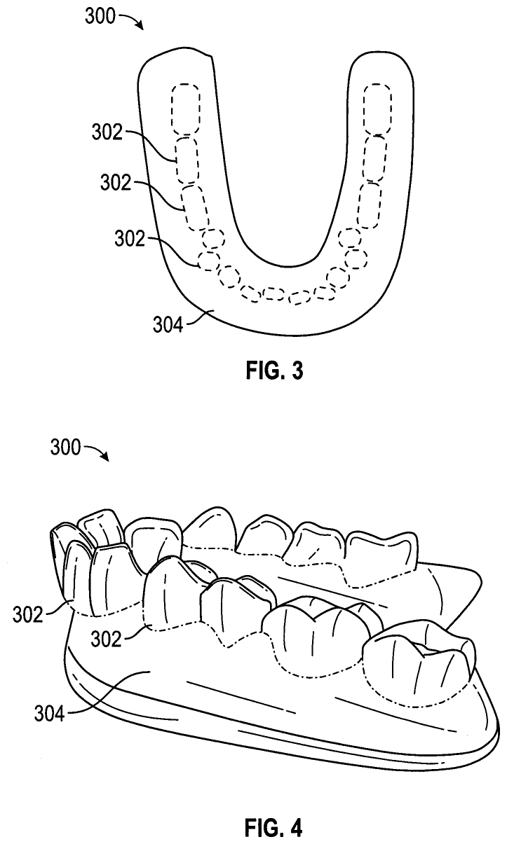

Referring to FIG. 2-FIG. 4, the intake computing system 104 may be configured to generate a 3D model of a dentition. Specifically, FIG. 3 and FIG. 4 show a simplified top-down view and a side perspective view of a 3D model of a dentition, respectively, according to illustrative embodiments. In some embodiments, the intake computing system 104 may be communicably coupled to or otherwise include one or more scanning devices 214. The intake computing system 104 may be communicably coupled to the scanning devices 214 via a wired or wireless connection. The scanning devices 214 may be or include any device, component, or hardware designed or implemented to generate, capture, or otherwise produce a 3D model 300 of an object, such as a dentition or dental arch. In some embodiments, the scanning devices 214 may include intraoral scanners configured to generate a 3D model of a dentition of a patient as the intraoral scanner passes over the dentition of the patient. For example, the intraoral scanner may be used during an intraoral scanning appointment, such as the intraoral scanning appointments described in U.S. Provisional Patent Appl. No. 62/660,141, titled “Arrangements for Intraoral Scanning,” filed Apr. 19, 2018, and U.S. patent application Ser. No. 16/130,762, titled “Arrangements for Intraoral Scanning,” filed Sep. 13, 2018. In some embodiments, the scanning devices 214 may include 3D scanners configured to scan a dental impression. The dental impression may be captured or administered by a patient using a dental impression kit similar to the dental impression kits described in U.S. Patent Application No. U.S. Provisional Patent Appl. No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, the contents of each of which are incorporated herein by reference in their entirety. In these and other embodiments, the scanning devices 214 may generally be configured to generate a 3D digital model of a dentition of a patient. The scanning device(s) 214 may be configured to generate a 3D digital model of the upper (i.e., maxillary) dentition and/or the lower (i.e., mandibular) dentition of the patient. The 3D digital model may include a digital representation of the patient's teeth 302 and gingiva 304. The scanning device(s) 214 may be configured to generate 3D digital models of the patient's dentition prior to treatment (i.e., with their teeth in an initial position). In some embodiments, the scanning device(s) 214 may be configured to generate the 3D digital models of the patient's dentition in real-time (e.g., as the dentition/impression) is scanned. In some embodiments, the scanning device(s) 214 may be configured to export, transmit, send, or otherwise provide data obtained during the scan to an external source which generates the 3D digital model, and transmits the 3D digital model to the intake computing system 104.

The intake computing system 104 may be configured to transmit, send, or otherwise provide the 3D digital model to the treatment planning computing system 102. In some embodiments, the intake computing system 104 may be configured to provide the 3D digital model of the patient's dentition to the treatment planning computing system 102 by uploading the 3D digital model to a patient file for the patient. The intake computing system 104 may be configured to provide the 3D digital model of the patient's upper and/or lower dentition at their initial (i.e., pre-treatment) position. The 3D digital model of the patient's upper and/or lower dentition may together form initial scan data which represents an initial position of the patient's teeth prior to treatment.

The treatment planning computing system 102 may be configured to receive the initial scan data from the intake computing system 104 (e.g., from the scanning device(s) 214 directly, indirectly via an external source following the scanning device(s) 214 providing data captured during the scan to the external source, etc.). As described in greater detail below, the treatment planning computing system 102 may include one or more treatment planning engines 118 configured or designed to generate a treatment plan based on or using the initial scan data.

Referring to FIG. 2, the treatment planning computing system 102 is shown to include a scan pre-processing engine 202. The scan pre-processing engine 202 may be or include any device(s), component(s), circuit(s), or other combination of hardware components designed or implemented to modify, correct, adjust, or otherwise process initial scan data received from the intake computing system 104 prior to generating a treatment plan. The scan pre-processing engine 202 may be configured to process the initial scan data by applying one or more surface smoothing algorithms to the 3D digital models. The scan pre-processing engine 202 may be configured to fill one or more holes or gaps in the 3D digital models. In some embodiments, the scan pre-processing engine 202 may be configured to receive inputs from a treatment planning terminal 108 to process the initial scan data. For example, the scan pre-processing engine 202 may be configured to receive inputs to smooth, refine, adjust, or otherwise process the initial scan data.

The inputs may include a selection of a smoothing processing tool presented on a user interface of the treatment planning terminal 108 showing the 3D digital model(s). As a user of the treatment planning terminal 108 selects various portions of the 3D digital model(s) using the smoothing processing tool, the scan pre-processing engine 202 may correspondingly smooth the 3D digital model at (and/or around) the selected portion. Similarly, the scan pre-processing engine 202 may be configured receive a selection of a gap filling processing tool presented on the user interface of the treatment planning terminal 108 to fill gaps in the 3D digital model(s).

In some embodiments, the scan pre-processing engine 202 may be configured to receive inputs for removing a portion of the gingiva represented in the 3D digital model of the dentition. For example, the scan pre-processing engine 202 may be configured to receive a selection (on a user interface of the treatment planning terminal 108) of a gingiva trimming tool which selectively removes gingival form the 3D digital model of the dentition. A user of the treatment planning terminal 108 may select a portion of the gingiva to remove using the gingiva trimming tool. The portion may be a lower portion of the gingiva represented in the digital model opposite the teeth. For example, where the 3D digital model shows a mandibular dentition, the portion of the gingiva removed from the 3D digital model may be the lower portion of the gingiva closest to the lower jaw. Similarly, where the 3D digital model shows a maxillary dentition, the portion of the gingiva removed from the 3D digital model may be the upper portion of the gingiva closest to the upper jaw.

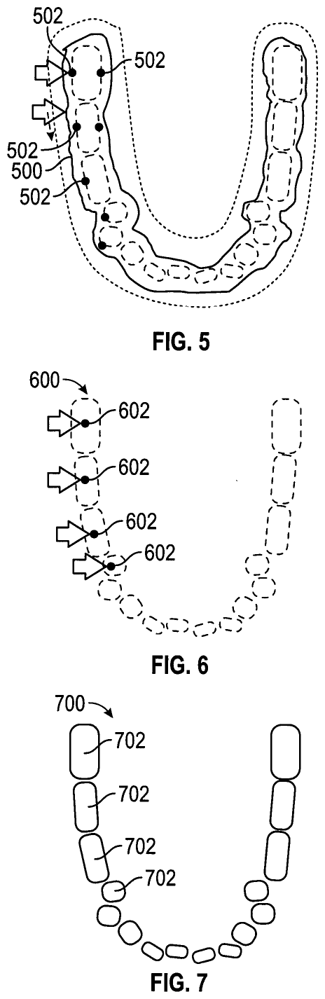

Referring now to FIG. 2 and FIG. 5, the treatment planning computing system 102 is shown to include a gingival line processing engine 204. Specifically, FIG. 5 shows a trace of a gingiva-tooth interface on the model 300 shown in FIG. 3 and FIG. 4. The gingival line processing engine 204 may be or include any device(s), component(s), circuit(s), or other combination of hardware components designed or implemented to determine, identify, or otherwise define a gingival line of the 3D digital models. The gingival line may be or include the interface between the gingiva and teeth represented in the 3D digital models. In some embodiments, the gingival line processing engine 204 may be configured to receive inputs from the treatment planning terminal 108 for defining the gingival line. The treatment planning terminal 108 may show a gingival line defining tool on a user interface which includes the 3D digital models.

The gingival line defining tool may be used for defining or otherwise determining the gingival line for the 3D digital models. As one example, the gingival line defining tool may be used to trace a rough gingival line 500. For example, a user of the treatment planning terminal 108 may select the gingival line defining tool on the user interface, and drag the gingival line defining tool along an approximate gingival line of the 3D digital model. As another example, the gingival line defining tool may be used to select (e.g., on the user interface shown on the treatment planning terminal 108) lowest points 502 at the teeth-gingiva interface for each of the teeth in the 3D digital model.

The gingival line processing engine 204 may be configured to receive the inputs provided by the user via the gingival line defining tool on the user interface of the treatment planning terminal 108 for generating or otherwise defining the gingival line. In some embodiments, the gingival line processing engine 204 may be configured to use the inputs to identify a surface transition on or near the selected inputs. For example, where the input selects a lowest point 502 (or a portion of the rough gingival line 500 near the lowest point 502) on a respective tooth, the gingival line processing engine 204 may identify a surface transition or seam at or near the lowest point 502 which is at the gingival margin. The gingival line processing engine 204 may define the transition or seam as the gingival line. The gingival line processing engine 204 may define the gingival line for each of the teeth 302 included in the 3D digital model 300. The gingival line processing engine 204 may be configured to generate a tooth model using the gingival line of the teeth 302 in the 3D digital model 300. The gingival line processing engine 204 may be configured to generate the tooth model by separating the 3D digital model along the gingival line. The tooth model may be the portion of the 3D digital model which is separated along the gingival line and includes digital representations of the patient's teeth.

Referring now to FIG. 2 and FIG. 6, the treatment planning computing system 102 is shown to include a segmentation processing engine 206. Specifically, FIG. 6 shows a view of the tooth model 600 generated by the gingival line processing engine 204. The segmentation processing engine 206 may be or include any device(s), component(s), circuit(s), or other combination of hardware components designed or implemented to determine, identify, or otherwise segment individual teeth from the tooth model. In some embodiments, the segmentation processing engine 206 may be configured to receive inputs (e.g., via a user interface shown on the treatment planning terminal 108) which select the teeth (e.g., points 602 on the teeth) in the tooth model 600. For example, the user interface may include a segmentation tool which, when selected, allows a user to select points 602 on each of the individual teeth in the tooth model 600. In some embodiments, the selection of each teeth may also assign a label to the teeth. The label may include tooth numbers (e.g., according to FDI world dental federation notation, the universal numbering system, Palmer notation, etc.) for each of the teeth in the tooth model 600. As shown in FIG. 6, the user may select individual teeth in the tooth model 600 to assign a label to the teeth.

Referring now to FIG. 7, depicted is a segmented tooth model 700 generated from the tooth model 600 shown in FIG. 6. The segmentation processing engine 206 may be configured to receive the selection of the teeth from the user via the user interface of the treatment planning terminal 108. The segmentation processing engine 206 may be configured to separate each of the teeth selected by the user on the user interface. For example, the segmentation processing engine 206 may be configured to identify or determine a gap between two adjacent points 602. The segmentation processing engine 206 may be configured to use the gap as a boundary defining or separating two teeth. The segmentation processing engine 206 may be configured to define boundaries for each of the teeth in the tooth model 600. The segmentation processing engine 206 may be configured to generate the segmented tooth model 700 including segmented teeth 702 using the defined boundaries generated from the selection of the points 602 on the teeth in the tooth model 600.

The treatment planning computing system 102 is shown to include a geometry processing engine 208. The geometry processing engine 208 may be or include any device(s), component(s), circuit(s), or other combination of hardware components designed or implemented to determine, identify, or otherwise generate whole tooth models for each of the teeth in the 3D digital model. Once the segmentation processing engine 206 generates the segmented tooth model 700, the geometry processing engine 208 may be configured to use the segmented teeth to generate a whole tooth model for each of the segmented teeth. Since the teeth have been separated along the gingival line by the gingival line processing engine 204 (as described above with reference to FIG. 6), the segmented teeth may only include crowns (e.g., the segmented teeth may not include any roots). The gingival line processing engine 204 may be configured to generate a whole tooth model including both crown and roots using the segmented teeth. In some embodiments, the segmentation processing engine 206 may be configured to generate the whole tooth models using the labels assigned to each of the teeth in the segmented tooth model 700. For example, the geometry processing engine 208 may be configured to access a tooth library 216. The tooth library 216 may include a library or database having a plurality of whole tooth models. The plurality of whole tooth models may include tooth models for each of the types of teeth in a dentition. The plurality of whole tooth models may be labeled or grouped according to tooth numbers.

The geometry processing engine 208 may be configured to generate the whole tooth models for a segmented tooth by performing a look-up function in the tooth library 216 using the label assigned to the segmented tooth to identify a corresponding whole tooth model. The geometry processing engine 208 may be configured to morph the whole tooth model identified in the tooth library 216 to correspond to the shape (e.g., surface contours) of the segmented tooth. In some embodiments, the geometry processing engine 208 may be configured to generate the whole tooth model by stitching the morphed whole tooth model from the tooth library 216 to the segmented tooth, such that the whole tooth model includes a portion (e.g., a root portion) from the tooth library 216 and a portion (e.g., a crown portion) from the segmented tooth. In some embodiments, the geometry processing engine 208 may be configured to generate the whole tooth model by replacing the segmented tooth with the morphed tooth model from the tooth library. In these and other embodiments, the geometry processing engine 208 may be configured to generate whole tooth models, including both crown and roots, for each of the teeth in a 3D digital model. The whole tooth models of each of the teeth in the 3D digital model may depict, show, or otherwise represent an initial position of the patient's dentition.

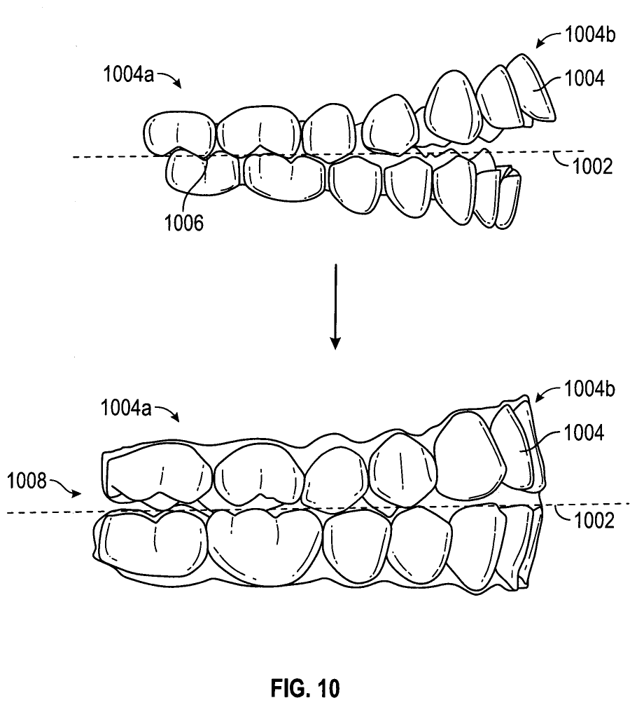

Referring now to FIG. 2, FIG. 8, and FIG. 10, the treatment planning computing system 102 is shown to include a final position processing engine 210. FIG. 8 shows one example of a target final position of the dentition from the initial position of the dentition shown in FIG. 7 from a top-down view. FIG. 10 shows one example of a target final position of the dentition from the initial position of the dentition shown in FIG. 7 from a side view. Specifically, FIG. 10 shows one example of a target final position of each of the upper and lower detentions relative to an occlusal axis, such as the longitudinal axis of each tooth (e.g., the axis extending between the upper and lower dentition), as will be described below. In some examples of the initial position, some teeth (e.g., upper and lower teeth) may contact one another when the upper and lower jaws close together, whereas other teeth (e.g., upper and lower teeth) may not contact one another. As shown in FIG. 10, the target final position may include an optimized bite alignment between the upper dentition and the lower dentition.

The final position processing engine 210 may be or may include any device(s), component(s), circuit(s), or other combination of hardware components designed or implemented to determine, identify, or otherwise generate a final position of the patient's teeth. The final position processing engine 210 may be configured to generate the treatment plan by manipulating individual 3D models of teeth within the 3D model (e.g., shown in FIG. 7). In some embodiments, the final position processing engine 210 may be configured to receive inputs for generating the final position of the patient's teeth. The final position may be a target position of the teeth post-orthodontic treatment or at a last stage of realignment. A user of the treatment planning terminal 108 may provide one or more inputs for each tooth or a subset of the teeth in the initial 3D model to move the teeth from their initial position to their final position (shown in dot-dash). For example, the treatment planning terminal 108 may be configured to receive inputs to drag, shift, rotate, or otherwise move individual teeth to their final position, incrementally shift the teeth to their final position, etc. The movements may include lateral/longitudinal movements, rotational movements, translational movements, etc. The movements may include intrusions and/or extrusions of the teeth relative to the occlusal axis, as will be described below.

In some embodiments, the manipulation of the 3D model may show a final (or target) position of the teeth of the patient following orthodontic treatment or at a last stage of realignment via dental aligners. In some embodiments, the final position processing engine 210 may be configured to apply one or more movement thresholds (e.g., a maximum lateral and/or rotational movement for treatment) to each of the individual 3D teeth models for generating the final position. As such, the final position may be generated in accordance with the movement thresholds.

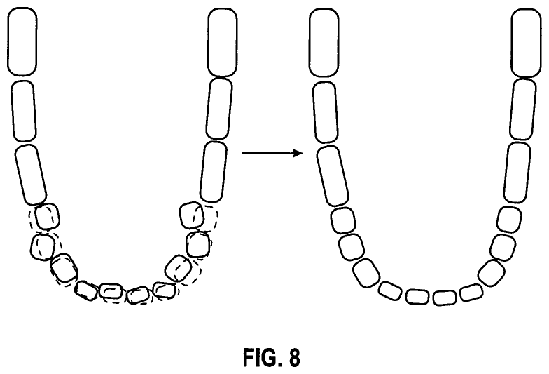

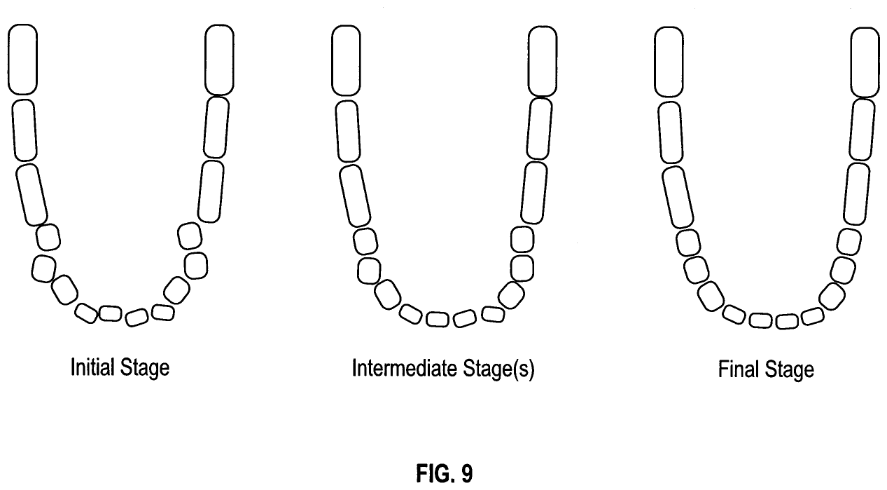

Referring now to FIG. 2 and FIG. 9, the treatment planning computing system 102 is shown to include a staging processing engine 212. Specifically, FIG. 9 shows a series of stages of the dentition from the initial position shown in FIG. 7 to the target final position shown in FIG. 8 and FIG. 10, according to an illustrative embodiment. The staging processing engine 212 may be or include any device(s), component(s), circuit(s), or other combination of hardware components designed or implemented to determine, identify, or otherwise generate stages of treatment from the initial position to the final position of the patient's teeth. In some embodiments, the staging processing engine 212 may be configured to receive inputs (e.g., via a user interface of the treatment planning terminal 108) for generating the stages. In some embodiments, the staging processing engine 212 may be configured to automatically compute or determine the stages based on the movements from the initial to the final position. The staging processing engine 212 may be configured to apply one or more movement thresholds (e.g., a maximum lateral and/or rotational movement for a respective stage) to each stage of treatment plan. The staging processing engine 212 may be configured to generate the stages as 3D digital models of the patient's teeth as they progress from their initial position to their final position. For example, and as shown in FIG. 9, the stages may include an initial stage including a 3D digital model of the patient's teeth at their initial position, one or more intermediate stages including 3D digital model(s) of the patient's teeth at one or more intermediate positions, and a final stage including a 3D digital model of the patient's teeth at the final position.

In some embodiments, the staging processing engine 212 may be configured to generate at least one intermediate stage for each tooth based on a difference between the initial position of the tooth and the final position of the tooth. For instance, where the staging processing engine 212 generates one intermediate stage, the intermediate stage may be a halfway point between the initial position of the tooth and the final position of the tooth. Each of the stages may together form a treatment plan for the patient, and may include a series or set of 3D digital models.

Following generating the stages, the treatment planning computing system 102 may be configured to transmit, send, or otherwise provide the staged 3D digital models to the fabrication computing system 106. In some embodiments, the treatment planning computing system 102 may be configured to provide the staged 3D digital models to the fabrication computing system 106 by uploading the staged 3D digital models to a patient file which is accessible via the fabrication computing system 106. In some embodiments, the treatment planning computing system 102 may be configured to provide the staged 3D digital models to the fabrication computing system 106 by sending the staged 3D digital models to an address (e.g., an email address, IP address, etc.) for the fabrication computing system 106.

The fabrication computing system 106 can include a fabrication computing device and fabrication equipment 218 configured to produce, manufacture, or otherwise fabricate dental aligners. The fabrication computing system 106 may be configured to receive a plurality of staged 3D digital models corresponding to the treatment plan for the patient. As stated above, each 3D digital model may be representative of a particular stage of the treatment plan (e.g., a first 3D model corresponding to an initial stage of the treatment plan, one or more intermediate 3D models corresponding to intermediate stages of the treatment plan, and a final 3D model corresponding to a final stage of the treatment plan).

The fabrication computing system 106 may be configured to send the staged 3D models to fabrication equipment 218 for generating, constructing, building, or otherwise producing dental aligners 220. In some embodiments, the fabrication equipment 218 may include a 3D printing system. The 3D printing system may be used to 3D print physical models corresponding the 3D models of the treatment plan. As such, the 3D printing system may be configured to fabricate physical models which represent each stage of the treatment plan. In some implementations, the fabrication equipment 218 may include casting equipment configured to cast, etch, or otherwise generate physical models based on the 3D models of the treatment plan. Where the 3D printing system generates physical models, the fabrication equipment 218 may also include a thermoforming system. The thermoforming system may be configured to thermoform a polymeric material to the physical models, and cut, trim, or otherwise remove excess polymeric material from the physical models to fabricate a dental aligner. In some embodiments, the 3D printing system may be configured to directly fabricate dental aligners 220 (e.g., by 3D printing the dental aligners 220 directly based on the 3D models of the treatment plan). Additional details corresponding to fabricating dental aligners 220 are described in U.S. Provisional Patent Appl. No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, and U.S. Pat. No. 10,315,353, titled “Systems and Methods for Thermoforming Dental Aligners,” filed Nov. 13, 2018, the contents of each of which are incorporated herein by reference in their entirety.

The fabrication equipment 218 may be configured to generate or otherwise fabricate dental aligners 220 for each stage of the treatment plan. In some instances, each stage may include a plurality of dental aligners 220 (e.g., a plurality of dental aligners 220 for the first stage of the treatment plan, a plurality of dental aligners 220 for the intermediate stage(s) of the treatment plan, a plurality of dental aligners 220 for the final stage of the treatment plan, etc.). Each of the dental aligners 220 may be worn by the patient in a particular sequence for a predetermined duration (e.g., two weeks for a first dental aligner 220 of the first stage, one week for a second dental aligner 220 of the first stage, etc.).

Referring now to FIG. 10, depicted is a side view of an upper and lower detention, showing movement of the upper and lower dentition of teeth relative to the occlusal axis from an example initial position to an example final position, according to an illustrative embodiment. For example, the upper and lower dental arches may move relative to one another to move towards and/or away from an occlusal plane 1002. In the illustrative embodiment shown in FIG. 10, the occlusal plane 1002 extends laterally between each side of the dentitions (e.g., into the page, out from the page). As described above, the final position (e.g., shown in the first model of FIG. 10) for each tooth 1004 may be defined, determined, or otherwise generated by the final position processing engine 210. As described above and in greater detail below, the final position processing engine 210 may be configured to generate or otherwise determine a final position of one or more teeth of the dentition, and the staging processing engine 212 and the output visualization engine 120 may be configured to determine and render one or more movements of the upper and/or lower dentitions relative to one another in various stages to progress from the initial position to the final position relative to the occlusal plane 1002. In some embodiments, the final position processing engine 210 may be configured to determine a movement of the upper and/or lower dental arches to decrease the distance between at least one tooth of the upper arch and at least one corresponding tooth of the lower arch, as described in greater detail below.

Throughout the various stages of the treatment plan, the final position processing engine 210 may be configured to move at least one portion of the upper and/or lower dental arches (e.g., one or more teeth) relative to the occlusal plane 1002. For example, as described above with reference to FIGS. 8 and 9, during the generated treatment plan, one or more teeth within a dentition may move at least some distance from an initial position to a final position. Specifically, FIG. 8 shows a target final position of the teeth of an upper or lower dentition. Further, during the generated treatment plan, the upper and/or lower arches may move at least some distance relative to one another from an initial position to a final position. For example, FIG. 10 shows a target final occlusal position (e.g., shown as target position 1008) of the upper and lower dentition relative to one another from the initial position. In some embodiments, the target position 1008 may correspond to the final stage target position shown in FIG. 8. In some embodiments, in the target final occlusal position, one or more posterior teeth of the upper dentition may contact one or more posterior teeth of the lower dentition (e.g., teeth positioned towards a posterior of a dentition shown as posterior teeth 1004a in FIG. 10, molar teeth) when the jaw is closed and/or stationary (e.g., in a closed-bite). In some embodiments, in the target final occlusal position, one or more anterior teeth of the upper dentition and lower dentition (e.g., teeth positioned towards an anterior of a body, shown as anterior teeth 1004b in FIG. 10) may not contact one another or may be positioned at a distance from one another.

As described in greater detail above in reference to FIG. 2, the final position processing engine 210 may be configured to receive a series of 3D representations of the upper dental arch and the lower dental arch (e.g., via the fabrication computing system 106). For example, the final position processing engine 210 may be configured to receive a 3D representation (e.g., 3D models) of the upper and lower dental arches throughout each stage of the treatment plan (e.g., iteratively at each stage). In some embodiments, the final position processing engine 210 may be configured to receive at least one 3D representation (e.g., 3D model) of the upper and lower dental arches at a final stage of the treatment plan. In some embodiments, the final position processing engine 210 may be configured to move one or more of the anterior upper teeth (e.g., anterior teeth 1004b of the upper dentition) and one or more anterior lower teeth (e.g., anterior teeth 1004b of the lower dentition) relative to one another and/or relative to (e.g., perpendicular to) the occlusal plane 1002.

In some embodiments, the final position processing engine 210 may be configured to identify a distance between one or more upper teeth and one or more corresponding lower teeth of a first 3D representation received. For example, the final position processing engine 210 may be configured to identify a distance between one or more anterior teeth 1004b of the upper dentition and one or more anterior teeth 1004b of the lower dentition relative to one another and/or relative to (e.g., perpendicular to) the occlusal plane 1002. In some embodiments, the final position processing engine 210 may be configured to identify a distance between one or more teeth of each of the upper and lower dentitions relative to one another and/or to the occlusal plane 1002 based on one or more inputs received from the treatment planning terminal 108. In some embodiments, the final position processing engine 210 may be configured to receive inputs for moving one or more posterior teeth 1004a of the upper and/or lower dentitions and identify a distance between one or more positions of the anterior teeth 1004b in response to the inputs received (e.g., to close a gap between the upper and lower dental arches). For example, the final position processing engine 210 may be configured to receive a keyboard input (e.g., on a user interface or input device of the treatment planning terminal 108) providing one or more inputs for each posterior tooth 1004a or a subset of the posterior teeth 1004a. The inputs may include, for example, an intrusion movement of a posterior tooth 1004a, such that one or more of the posterior teeth 1004a moves at least partially into a portion of the jaw. In some embodiments, the final position processing engine 210 may be configured to identify a distance between one or more of the anterior teeth 1004b in response to the one or more intrusion movement inputs from a user. For example, as described in greater detail below, the final position processing engine 210 may be configured to determine a distance between a surface of a tooth of the upper dental arch and a surface of a tooth of the lower dental arch. In some embodiments, the final position processing engine 210 may be configured to determine a contact density between a portion of the posterior teeth 1004a and/or the anterior teeth 1004b of the upper dentition and a portion of the posterior teeth 1004a and/or the anterior teeth 1004b of the lower dentition and, based on the determined contact density, detect a distance between the one or more anterior teeth 1004b relative to the occlusal plane 1002.

In some embodiments, the final position processing engine 210 may be configured to define the occlusal plane 1002 for the upper dentition and the lower dentition following the movements of the one or more posterior upper teeth and/or posterior lower teeth. In some embodiments, the final position processing engine 210 may define the occlusal plane 1002 such that the occlusal plane 1002 extends laterally between a first posterior tooth of the lower dentition (e.g., positioned on a right-hand side of the dentition) and a second posterior tooth of the lower dentition (e.g., positioned on an opposing left-hand side of the dentition). In some embodiments, the final position processing engine 210 may define the occlusal plane 1002 such that the occlusal plane 1002 extends laterally between a first posterior tooth of the upper dentition (e.g., positioned on a right-hand side of the dentition) and a second posterior tooth of the upper dentition (e.g., positioned on an opposing left-hand side of the dentition). In some embodiments, the occlusal plane 1002 can extend substantially perpendicular to a longitudinal axis of one of the posterior teeth 1004a (e.g., substantially perpendicular to the maxillary-mandibular axis extending between the upper and lower dentitions). In some embodiments, the occlusal plane 1002 can extend substantially parallel to a lateral axis of one of the posterior teeth 1004a (e.g., substantially parallel to the buccal-lingual axis extending from a one side of the tooth, such as the side closest to an inner portion of the cheek, to a second side of the tooth, such as the side closest to the tongue).

The final positon processing engine 210 may be configured to determine one or more movements to occlusally align the upper and lower dentitions. For example, the final position processing engine 210 may be configured to determine a movement of the upper and/or lower arches of the 3D representation relative to each other such that the upper dentition is aligned with (along an opposite side of the occlusal plane 1002) the lower dentition. In some embodiments, the final position processing engine 210 may be configured to determine a first occlusal contact of the upper dentition and the lower dentition. In some embodiments, the final position processing engine 210 may be configured to determine the first occlusal contact of the upper dentition and the lower dentition along the defined occlusal plane 1002. For example, the final position processing engine 210 may be configured to detect a point of contact between a first tooth of the upper dentition and a first tooth of the lower dentition positioned relative to the occlusal plane 1002 (e.g., when the jaw is closed, in a close-bite, etc.). In some embodiments, the detected first occlusal contact may be a point of contact between one or more teeth (e.g., two teeth, three teeth, etc.) of the upper dentition and one or more teeth of the lower dentition positioned relative to the occlusal plane 1002.

In some embodiments, the detected first occlusal contact may be a point of contact between a portion of the upper dentition and a portion of the lower dentition relative to the occlusal plane 1002, such as occlusal contact point 1006 shown in FIG. 10, according to one illustrative embodiment. In some embodiments, the final position processing engine 210 may be configured to detect a surface along various contact points of each tooth on the occlusal plane 1002 (e.g., an occlusal surface of each tooth). For example, the final position processing engine 210 may be configured to detect a distance between one or more upper teeth and one or more lower teeth as the distance between one or more points of each tooth positioned closest to or in line with the occlusal plane 1002 (e.g., distance along the maxillary-mandibular axis between an upper tooth and a lower tooth).

In some embodiments, the final position processing engine 210 may be configured to determine the contact density between the upper dentition and the lower dentition by measuring, calculating, or otherwise determining a minimum distance between each tooth of the upper dentition and each tooth of the lower dentition. In some embodiments, the final position processing engine 210 may be configured to determine the contact density between the upper dentition and the lower dentition by measuring, calculating, or otherwise determining the densest contact (e.g., closest contact, largest area of contact, etc.) between each tooth of the upper dentition and the lower dentition.

The final position processing engine 210 may be configured to generate a transformation for the upper and/or lower arches of the 3D representation. For example, the final position processing engine 210 may be configured to generate one or more affine transformations of the upper and/or lower arches, such as a rigid body transformation relative to one another and/or relative to the occlusal plane 1002. Generally, the transformation includes a combination of single transformation movements of the upper and/or lower arches, such as translation, rotation, and/or reflection about an axis. In some embodiments, the final position processing engine 210 may be configured to generate a transformation of the dental arches of the 3D representation with respect to a point 602 of a tooth (e.g., centroid of the tooth, occlusal surface of the tooth, etc.). In some embodiments, the final position processing engine 210 may be configured to generate a transformation of the dental arches with respect to a longitudinal axis of each respective dental arch (e.g., longitudinal axis extending between the gingival line 500 and the occlusal plane 1002, along the maxillary-mandibular axis, etc.). In some embodiments, the final position processing engine 210 may be configured to generate a transformation of the upper and/or lower dental arches with respect to a lateral axis of each respective arch (e.g., a lateral axis extending between a right-hand side of the arch and an opposing left-hand side of the arch, along the buccal-lingual axis, a lateral axis substantially parallel with the occlusal plane 1002, etc.).

In some embodiments, the generated transformation may include a parameterization of translational and rotational movements. For example, the final position processing engine 210 may be configured to generate a transformation parameterized by three or more values. In some embodiments, the final position processing engine 210 may be configured to generate a transformation parameterized by six values (e.g., three translational movements and three rotational movements, Euler angles, etc.). In some embodiments, the final position processing engine 210 may be configured to generate a transformation including movement of the upper and/or lower dental arch relative to the occlusal plane 1002. For example, the final position processing engine 210 may be configured to generate a transformation (e.g., based on six parameters) of the upper and/or lower dental arch relative to the occlusal plane 1002. In other words, each of the upper and lower dental arches can be rotated, translated, and/or reflected relative to the occlusal plane 1002 such that collinear points continue to be collinear after the transformation.

In some embodiments, the final position processing engine 210 may be configured to generate a transformation for the upper and/or lower arches based on the identified distance between one or more teeth of the upper and lower arches. For example, the final position processing engine 210 may be configured to determine a first occlusal contact in a first positon, such as the initial dentition position shown in FIG. 10. The final position processing engine 210 may be configured to detect a contact density of the first occlusal contact in the first position. The contact density refers to a degree or amount of contact of two teeth which are occlusally aligned with one another in a closed-bite. For example, the final position processing engine 210 may be configured to detect the contact density of the first occlusal contact in the first position based on each tooth's contact, protrusion, or other engagement with the occlusal plane 1002 defined between the upper and lower dentition. In other words, the final position processing engine 210 may be configured to determine the contact area between teeth of the upper and lower dentitions on the occlusal plane 1002 (e.g., contact density is about 0.1% of the cross-sectional area of each tooth, about 1% of the cross-sectional area of each tooth, about 5% of the cross-sectional area of each tooth, etc.). The final position processing engine 210 may be configured to detect a movement of the upper and/or lower arches to decrease the distance between the identified one or more teeth at the occlusal contact point. The movement of the dental arches may define a second position, described in greater detail below.

The final position processing engine 210 may be configured to determine a movement for the upper and/or lower arches according to the generated transformation to provide a second occlusal contact of the upper dentition and lower dentition relative to the occlusal plane 1002 to minimize a distance between the upper dentition and the lower dentition. For example, the final position processing engine 210 may be configured to determine the second occlusal contact in the second positon, such as an intermediate dentition position in between the initial positon and final position shown in FIGS. 8 and 10. The final position processing engine 210 may be configured to detect the contact density of the second occlusal contact in the second position based on each tooth's contact, protrusion, or other engagement with the occlusal plane 1002 defined between the upper and lower dentition. In other words, the final position processing engine 210 may be configured to determine the contact area between the one or more teeth of each of the upper and lower dentitions on the occlusal plane 1002 (e.g., contact density is about 0.1% of the cross-sectional area of each tooth, about 1% of the cross-sectional area of each tooth, about 5% of the cross-sectional area of each tooth, etc.) to determine the second occlusal contact density.

In some embodiments, the final position processing engine 210 may be configured to determine an optimized occlusal position between the upper and lower detentions relative to the occlusal plane 1002. For example, the final position processing engine 210 may be configured to distribute contact across the dental arch (e.g., generate relatively even contact density of teeth between the upper and lower dentitions across the dental arch). The final position processing engine 210 may be configured to maximize an overall contact area between the plurality of teeth of the upper dentition and the plurality of teeth of the lower dentition to minimize the distance between the upper dentition and lower dentition, as another example. The final position processing engine 210 may be configured to maximize the number of occlusal contacts (e.g., an amount of instances a tooth of the upper dentition contacts a tooth of the lower dentition) between the plurality of teeth of the upper dentition and the lower dentition to minimize the distance between the upper dentition and lower dentition, as another example. The final position processing engine 210 may be configured to determine that an occlusal contact for at least some teeth in the second position (e.g., the second occlusal contact determined in the second position described above) has a greater contact density than an occlusal contact for at least some teeth in the first position (e.g., the first occlusal contact determined in the first position described above). For example, the contact area of the second occlusal contact may be greater than the contact area of the first occlusal contact. The final position processing engine 210 may be configured to determine a movement of the upper and/or lower dental arches from the first position to the second position to facilitate optimizing the densest contact area between the upper and lower dentition.

In some embodiments, the output visualization engine 120 may be configured to generate a second 3D representation (e.g., 3D model) based on the determined movement to reflect the decrease in distance between the one or more teeth of the upper dental arch and the lower dental arch. For example, the output visualization engine 120 may be configured to render a visualization of a 3D model depicting the progression of the teeth of the upper dental arch and the lower dental arch on a user interface, as described below.

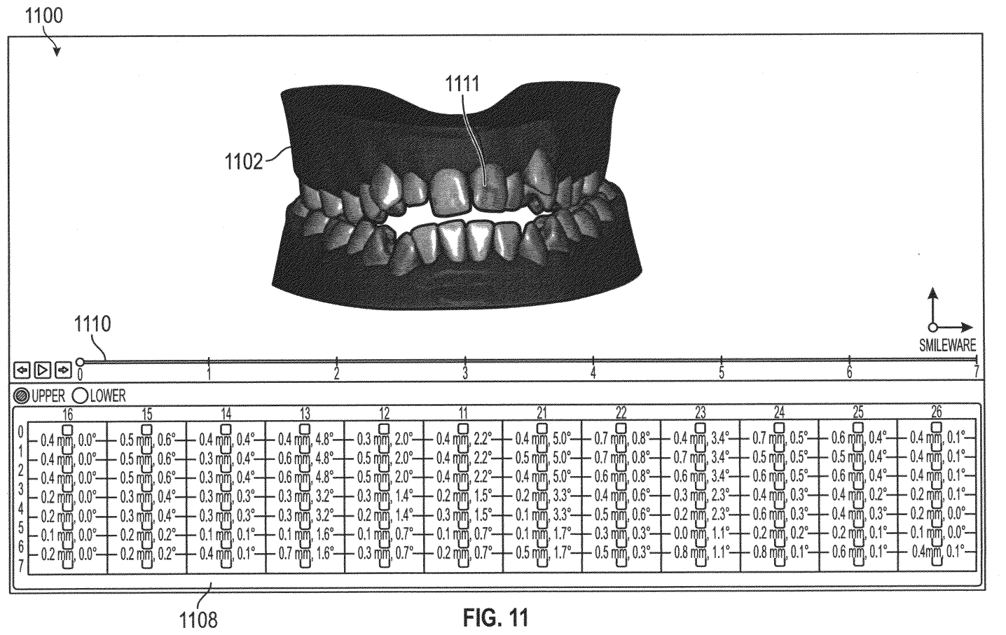

Referring now to FIG. 11, depicted is a user interface 1100 showing a 3D model 1102 of a dentition, according to an illustrative embodiment. The user interface 1100 may be displayed or otherwise rendered on a treatment planning terminal 108 described above. The user interface 1100 may include regions for selecting various visualized steps of generating the treatment plan as described above (e.g., segmentation by the segmentation processing engine 206, matching by the geometry processing engine 208, final position by the final position processing engine 210, etc.). Upon selecting a staging button, the user interface 1100 may be rendered on the treatment planning terminal 108 and used to generate stages and positions for the treatment plan as described herein.

The user interface 1100 is shown to include a staging region 1108 which shows movement of the upper and lower dentitions in the 3D model 1102. The teeth may be represented in the staging region 1108 according to various teeth numbers corresponding to a matching anterior or posterior tooth. For example, tooth number 11 shown in the staging region 1108 may correspond to a front-most anterior tooth on the right-hand side of the 3D model 1102 (e.g., shown as tooth 1111 in FIG. 11). The staging region 1108 may include rows which represent movement at each stage, and columns which represent each of the teeth.

The user interface 1100 may include a bite jump button which is configured to receive a user interaction. For example, as described in greater detail above, the 3D model 1102 may include one or more gaps between the upper dentition and lower dentition of the mouth. A user may select the bite jump button to automatically determine and render a final position of the upper and lower arches of the 3D model 1102, and to define stages for moving the upper and lower arches of the 3D model from the initial positon to the final position. The user interface 1100 may include a slide bar 1110 which is configured to receive a selection of a particular stage of the treatment plan. A user may select a play button to show a visual progression of the teeth from the initial position (e.g., at stage 0) to the final position (e.g., at stage 7 in the example shown in FIG. 11). In the example shown in FIG. 11, a user may have selected stage 0 on the slide bar 1110. Selecting a particular stage on the slide bar 1110 may highlight the corresponding row in the staging region 1108 of the user interface 1100. At each stage, the corresponding row may include a change in position of each tooth relative to a previous point in a previous stage. For example, the corresponding row may include a magnitude and direction of the change in position of a central point (e.g., centroid) of a tooth between the stage selected and the previous stage. The change in position may include both a translational measurement and a rotational measurement of each tooth relative to a position of the tooth in a previous stage (e.g., at stage 1 shown in FIG. 11, tooth 1111 corresponding to tooth number 11 moved 0.4 mm at a 2.2 degree angle relative to its previous position at stage 0).

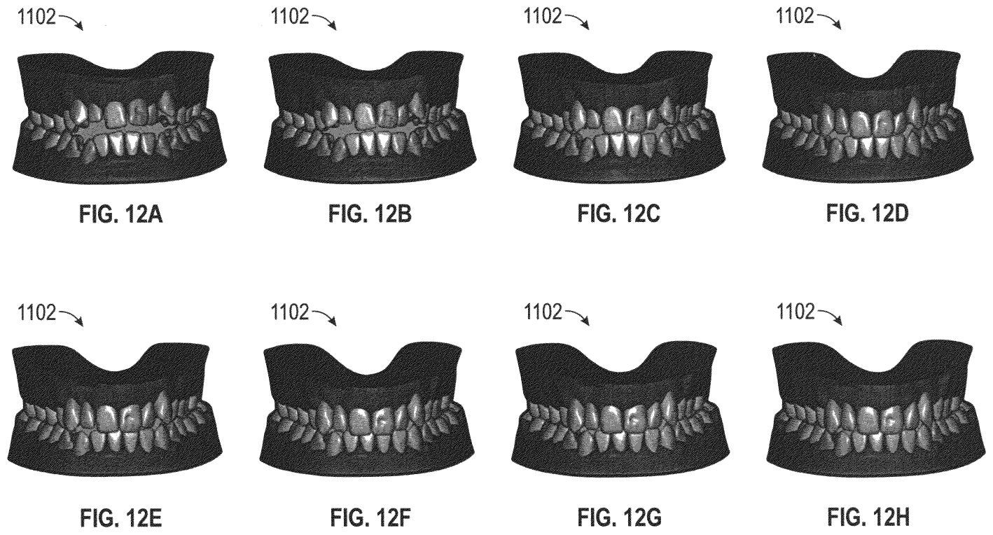

Referring now to FIG. 12A through FIG. 12H, depicted is the 3D model 1102 shown in the user interface 1100 through various stages of the treatment plan, according to an illustrative embodiment. For example, FIG. 12A depicts the 3D model 1102 in a first stage, FIG. 12B depicts the 3D model 1102 in a second stage, etc. The user interface 1100 may be rendered responsive to selecting a user interface element, such as a bite jump button on the user interface 1100 shown in FIG. 11. In some embodiments, the staging processing engine 212 and the output visualization engine 120 may be configured to execute one or more of the methods described herein to automatically generate and render the stages of the treatment plan responsive to selecting the bite jump button based on the final position determined by the final position processing engine 210. FIG. 12A depicts the 3D model in the first stage (e.g., stage 0, as shown in FIG. 11). In some embodiments, in the first stage, at least one anterior tooth of the upper dentition of the 3D model 1102 may not make contact with an anterior tooth of the lower dentition.

FIG. 12B depicts the 3D model 1102 in a second stage (e.g., stage 1 of the slide bar 1110 in FIG. 11), according to an illustrative embodiment. In some embodiments, at the second stage, at least one portion of the upper dental arch (e.g., the upper jaw) of the 3D model 1102 may move closer to the occlusal plane 1002. In some embodiments, at least one portion of the lower dentition (e.g., the lower jaw) of the 3D model 1102 may move closer to the occlusal plane. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12B, a tooth moved relative to its previous position (e.g., a portion of the upper dentition and/or lower dentition moved such that tooth 24 is moved 0.5 mm at an angle of 0.5 degrees relative to its previous position at stage 0). In some embodiments, the staging region 1108 illustrates each movement of each tooth between each stage, as shown in FIG. 11.

Continuing with the example user interface 1100 shown in FIG. 11, FIG. 12C depicts the 3D model 1102 in a third stage (e.g., stage 2 of the slide bar 1110 in FIG. 11), according to an illustrative embodiment. In some embodiments, at the third stage, at least one portion of the upper dentition of the 3D model 1102 moves closer to the occlusal plane 1002. In some embodiments, at least one portion of the lower dentition of the 3D model 1102 may move closer to the occlusal plane 1002. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12C, a tooth is moved relative to its previous position (e.g., a portion of the upper dentition and/or lower dentition moved such that tooth 12 is moved 0.4 mm at an angle of 2.2 degrees relative to its previous position at stage 1).

Continuing with the example user interface 1100 shown in FIG. 11, FIG. 12D depicts the 3D model 1102 in a fourth stage (e.g., stage 3 of the slide bar 1110 in FIG. 11), according to an illustrative embodiment. In some embodiments, at the fourth stage, at least one portion of the upper dentition of the 3D model 1102 may move closer to the occlusal plane 1002. In some embodiments, at least one portion of the lower dentition of the 3D model 1102 may move closer to the occlusal plane 1002. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12D, a tooth is moved relative to its previous position (e.g., a portion of the upper dentition and/or lower dentition moved such that tooth 15 is moved 0.5 mm at an angle of 0.6 degrees relative to its previous position at stage 2).

Continuing with the example user interface 1100 shown in FIG. 11, FIG. 12E depicts the 3D model 1102 in a fifth stage (e.g., stage 4 of the slide bar 1110 in FIG. 11), according to an illustrative embodiment. In some embodiments, at the fifth stage, at least one portion of the upper dentition of the 3D model 1102 may move closer to the occlusal plane 1002. In some embodiments, at least one portion of the lower dentition of the 3D model 1102 may move closer to the occlusal plane 1002. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12E, a portion of the upper dentition and/or lower dentition moved such that a tooth is moved relative to its previous position (e.g., tooth 21 moved is 0.2 mm at an angle of 3.3 degrees relative to its previous position at stage 3).

Continuing with the example user interface 1100 shown in FIG. 11, FIG. 12F depicts the 3D model 1102 in a sixth stage (e.g., stage 5 of the slide bar 1110 in FIG. 11), according to an illustrative embodiment. In some embodiments, at the sixth stage, at least one portion of the upper dentition of the 3D model 1102 may move closer to the occlusal plane 1002. In some embodiments, at least one portion of the lower dentition of the 3D model 1102 may move closer to the occlusal plane 1002. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12F, a tooth is moved relative to its previous position (e.g., a portion of the upper dentition and/or lower dentition moved such that tooth 25 is moved 0.4 mm at an angle of 0.3 degrees relative to its previous position at stage 4).

Continuing with the example user interface 1100 shown in FIG. 11, FIG. 12G depicts the 3D model 1102 in a seventh stage (e.g., stage 6 of the slide bar 1110 in FIG. 11), according to an illustrative embodiment. In some embodiments, at the seventh stage, at least one portion of the upper dentition of the 3D model 1102 may move closer to the occlusal plane 1002. In some embodiments, at least one portion of the lower dentition of the 3D model 1102 may move closer to the occlusal plane 1002. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12G, a tooth is moved relative to its previous position (e.g., a portion of the upper dentition and/or lower dentition moved such that tooth 13 is moved 0.1 mm at an angle of 1.6 degrees relative to its previous position at stage 5).

Continuing with the example user interface 1100 shown in FIG. 11, FIG. 12H depicts the 3D model 1102 in an eighth stage (e.g., stage 7 of the slide bar 1110 in FIG. 11), according to an illustrative embodiment. In some embodiments, at the eighth stage, at least one portion of the upper dentition of the 3D model 1102 may move closer to the occlusal plane 1002. In some embodiments, at least one portion of the lower dentition of the 3D model 1102 may move closer to the occlusal plane 1002. In some embodiments, at least one portion of the upper and/or lower dentition may move further away from the occlusal plane 1002. In some embodiments, at least one portion of the upper and/or lower dentition of the 3D model 1102 may rotate relative to the occlusal plane 1002. In the illustrative embodiment shown in FIG. 12H, a tooth is moved relative to its previous position (e.g., a portion of the upper dentition and/or lower dentition moved such that tooth 22 is moved 0.5 mm at an angle of 0.3 degrees relative to its previous position at stage 6). In some embodiments, the eighth stage (e.g., stage 7 selected on the slide bar 1110) may be a target final position of the treatment plan. In some embodiments, the treatment plan may include more or less stages. In some embodiments, the treatment plan may include two stages between an initial and final position. In some embodiments, the treatment plan may include nine or more stages between an initial and final position.

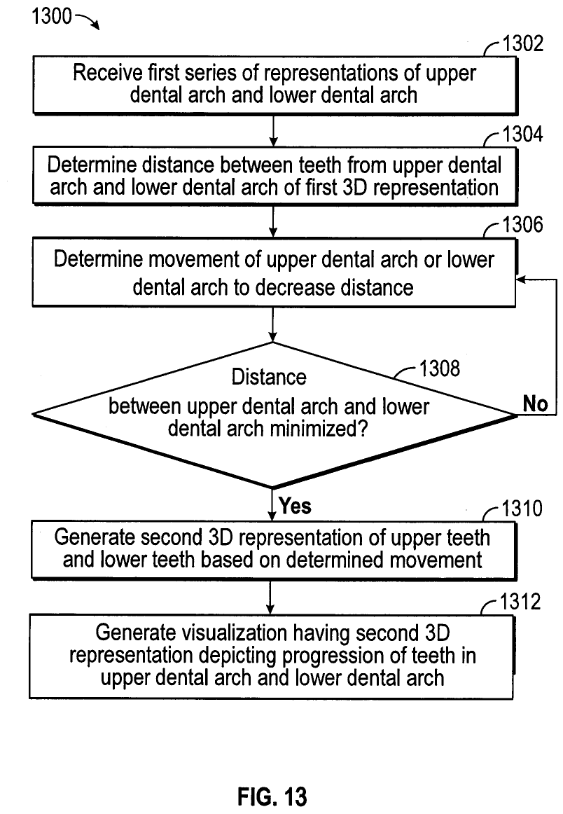

Referring now to FIG. 13, depicted is a flowchart showing a method 1300 of generating a treatment plan, according to an illustrative embodiment. The steps of the method 1300 may be performed by one or more of the components described above with reference to FIG. 1-FIG. 12H.

As an overview, the treatment planning computer system 102 may receive a first series of 3D models of an upper and lower dental arch at step 1302. At step 1304, the final position processing engine 210 may identify a distance between at least one tooth from the upper dental arch and at least one corresponding tooth of the lower dental arch. At step 1306, the final position processing engine 210 may determine a movement of at least one of the upper dental arch or the lower dental arch to decrease the distance. At step 1308, the final position processing engine 210 may determine whether the distance between the at least one tooth of the upper dental arch and the at least one corresponding tooth of the lower dental arch is at a minimum distance. Based on this step, the output visualization engine 120 may generate a second 3D representation of the plurality of upper teeth and the plurality of lower teeth based on the determined movement at step 1310 or the final position processing engine 210 may return to step 1306 where the final position processing engine 210 may determine another movement of the upper dental arch and/or the lower dental arch. At step 1312, the visualization manager 120 may generate a visualization having the second 3D representation depicting the progression of the teeth in the upper dental arch and the lower dental arch.

In greater detail, at step 1302, the treatment planning computer system 102 may receive a series of 3D models of an upper dental arch and a lower dental arch. As described above, each of the upper dental arch and the lower dental arch may include a plurality of upper teeth and a plurality of lower teeth, respectively. The series of 3D models of the upper dental arch and the lower dental arch may show a progression of the upper and lower arches between an initial position and a final position, as described in greater detail above. In some embodiments, the final position processing engine 210 may receive a first 3D representation of a dentition including representations of a plurality of teeth of the dentition in an initial position. In some embodiments, the final position processing engine 210 may receive the first 3D representation from the scanning devices 214 described above with reference to FIG. 2. For example, the final position processing engine 210 may receive the first 3D representation from a scanning device 214 which scanned a patient's dentition (e.g., directly as an intraoral scanner, or indirectly by scanning impressions captured by the patient). In some embodiments, the final position processing engine 210 may receive the initial 3D representation from one of the engines of the treatment planning computing system 102 (such as the geometry processing engine 208, for example). In some embodiments, the final position processing engine 210 may receive the series of 3D representations from each stage of the treatment plan described in greater detail above.

At step 1304, the final position processing engine 210 may identify a distance between at least one tooth from the upper dental arch and at least one corresponding tooth from the lower dental arch for the first 3D representation (e.g., of the series). For example, the final position processing engine 210 may identify a distance between one or more teeth of the lower dental arch and one or more teeth of the upper dental arch in an initial stage of the treatment plan. The final processing engine 210 may identify a distance between one or more teeth of the lower dental arch and one or more teeth of the upper dental arch in an intermediate stage of the treatment plan, as another example. The final processing engine 210 may identify a distance between one or more teeth of the lower dental arch and one or more teeth of the upper dental arch in a final stage of the treatment plan, as yet another example. In some embodiments, the final position processing engine 210 may identify a distance between one or more teeth of the lower dental arch and one or more teeth of the upper dental arch in response to one or more user inputs received from the treatment planning terminal 108, as described above. For example, the final position processing engine 210 may detect a distance between an upper tooth and a lower tooth as the distance between one or more points of each tooth positioned closest to or in line with an occlusal plane 1002 (e.g., distance along the maxillary-mandibular axis between an upper tooth and a lower tooth).

At step 1306, the final position processing engine 210 may determine a movement of the upper dental arch and/or the lower dental arch. In some embodiments, the final position processing engine 210 may determine a movement of the upper dental arch and/or the lower dental arch to decrease the identified distance (e.g., such that at least one tooth of the upper dental arch moves closer to at least one corresponding tooth of the lower dental arch). In some embodiments, the final position processing engine 210 may determine a movement of the upper dental arch and/or the lower dental arch to eliminate the identified distance (e.g., such that at least one tooth of the upper dental arch makes contact with at least one corresponding tooth of the lower dental arch). In some embodiments, the final position processing engine 210 may determine a movement of the upper dental arch and/or the lower dental arch using a transformation (e.g., rigid body transformation) of the upper dental arch and/or the lower dental arch.

At step 1308, the final position processing engine 210 may determine whether the identified distance is a minimum distance. For example, the final position processing engine 210 may detect the minimum distance as the smallest distance (e.g., space, gap, etc.) between one or more contact points of one or more upper and lower teeth of the upper and lower dental arches. In some embodiments, the final position processing engine 210 may determine that there is no distance between one or more teeth of the upper dental arch and corresponding teeth of the lower dental arch. In some embodiments, the final position processing engine 210 may determine a first occlusal contact of one or more teeth of the upper and/or lower dental arches relative to the occlusal plane 1002 by detecting one or more points of contact between a first tooth of the upper dental arch and a first tooth of the lower dental arch positioned relative to the occlusal plane 1002 (e.g., when the jaw is closed, in a close-bite, etc.). In some embodiments, the detected first occlusal contact may be a point of contact between one or more teeth (e.g., two teeth) of the upper dental arch and one or more teeth of the lower dental arch positioned relative to the occlusal plane 1002, as described above in reference to FIG. 10.

Following determining that the distance is not minimized, the final processing engine 210 may return to step 1306, where the final processing engine 210 determine a movement of the upper dental arch and/or the lower dental arch to continue to decrease the distance between the upper dental arch and the lower dental arch. As such, the final position processing engine 210 may iteratively loop between steps 1306 and 1308 until the final position processing engine 210 determines a minimized distance between the upper and lower dental arches. For example, the final position processing engine 210 may iteratively loop between steps 1306 and 1308 to generate various transformations of the upper and/or lower dental arches until an optimized contact density between the upper and lower arch (e.g., between the upper and lower teeth) is reached. In some embodiments, the final position processing engine 210 may generate one transformation until an optimized contact density is reached. In some embodiments, the final position processing engine 210 may generate more than one transformations until an optimized contact density is reached.

Following determining that the distance is minimized, the output visualization engine 120 may generate a second 3D representation of the plurality of upper teeth and the plurality of lower teeth based on the determined movement at step 1310. For example, the output visualization engine 120 may generate a second 3D model to reflect the minimized distance between the upper dental arch and the lower dental arch.

At step 1312, the output visualization engine 120 may generate a visualization having the second 3D representation depicting the progression of teeth in the upper dental arch and/or the lower dental arch. For example, in some embodiments, the output visualization engine 120 may render the visualization of the second 3D representation of the upper and lower dental arches on a user interface 1100 showing the progression of the plurality of upper and lower teeth iteratively at each stage of the treatment plan, as described above, and/or at a final stage of the treatment plan.

In some embodiments, the final position processing engine 210 may determine whether an occlusal contact for at least some of the teeth in the second position has a contact density greater than an occlusal contact for some of the teeth in the first position. For example, the final position processing engine 210 may detect a contact density between one or more teeth of the upper dental arch and the lower dental arch based on each tooth's contact, protrusion, or otherwise engagement with the occlusal plane 1002 defined between the upper and lower arches. In other words, the final position processing engine 210 may determine the contact area between the one or more teeth of each of the upper and lower arches on the occlusal plane 1002 (e.g., contact density is about 0.1% of the cross-sectional area of each tooth, about 1% of the cross-sectional area of each tooth, about 5% of the cross-sectional area of each tooth, etc.) to determine an occlusal contact density to determine a minimum distance. In some embodiments, the final position processing engine 210 may determine an optimized occlusal position between the upper and lower dental arches relative to the occlusal plane 1002. For example, the final position processing engine 210 may determine a distributed contact across the dental arches (e.g., generate relatively even contact density of teeth between the upper and lower arches). The final position processing engine 210 may maximize an overall contact area between the plurality of teeth of the upper arch and the plurality of teeth of the lower arch, as another example. The final position processing engine 210 may maximize the number of occlusal contacts (e.g., an amount of instances a tooth of the upper arch contacts a tooth of the lower arch) between the plurality of teeth of the upper dentition and the lower dentition, as yet another example.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the F. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems, apparatuses, and methods shown in the various exemplary embodiments is illustrative only. Additionally, any element disclosed in one embodiment may be incorporated or utilized with any other embodiment disclosed herein. For example, any of the exemplary embodiments described in this application can be incorporated with any of the other exemplary embodiment described in the application. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method, comprising:
receiving, by one or more processors, a first series of three-dimensional (3D) representations of an upper dental arch and a lower dental arch, the first series of 3D representations showing a progression of teeth in the upper dental arch and the lower dental arch from an initial position to a final position;
determining, by the one or more processors, for a first 3D representation of the first series of 3D representations, a distance between at least one tooth from the upper dental arch and a corresponding at least one tooth from the lower dental arch;
determining, by the one or more processors, using a transformation, a movement of at least one of the upper dental arch or the lower dental arch to decrease the distance between the at least one tooth from the upper dental arch and the corresponding at least one tooth from the lower dental arch;
generating, by the one or more processors, a second 3D representation of the plurality of upper teeth and the plurality of lower teeth based on the determined movement to reflect the decreased distance; and
generating, by the one or more processors, a visualization comprising the second 3D representation, the visualization depicting the progression of the teeth in the upper dental arch and the lower dental arch.

2. The method of claim 1, wherein determining the movement of at least one of the upper dental arch or the lower dental arch includes determining a movement from a first contact position having a first occlusal contact to a second contact position having a second occlusal contact.

3. The method of claim 1, wherein the transformation is a rigid body transformation comprising a parameterization of at least one of a translational or a rotational movement of at least one of the upper dental arch or the lower dental arch.

4. The method of claim 1, further comprising:
receiving, by the one or more processors, from a treatment planning terminal, inputs for moving at least one tooth from among the plurality of upper teeth and the plurality of lower teeth relative to an occlusal axis; and
determining, by the one or more processors, the distance between the at least one tooth from the upper dental arch and the corresponding at least one tooth from the lower dental arch in response to receiving the inputs for moving the at least one tooth from among the plurality of upper teeth and the plurality of lower teeth relative to the occlusal axis.

5. The method of claim 4, wherein the inputs for moving the one or more upper teeth and the one or more lower teeth relative to the occlusal axis comprise an intrusion movement.

6. The method of claim 4, wherein determining the distance between the at least one tooth from the upper dental arch and the corresponding at least one tooth from the lower dental arch is based on the inputs received from the treatment planning terminal.

7. The method of claim 1, wherein the decreased distance is a minimum distance defined by a maximum contact between the plurality of teeth of the upper dental arch and the plurality of teeth of the lower dental arch.

8. The method of claim 1, further comprising:
determining, by the one or more processors, for the first 3D representation of the first series of 3D representations, the distance between the at least one tooth from the upper dental arch and the corresponding at least one tooth from the lower dental arch is a minimum distance; and
generating, by the one or more processors, the second 3D representation of the plurality of upper teeth and the plurality of lower teeth to reflect the minimum distance.

9. The method of claim 1, wherein generating the second 3D representation of the plurality of upper teeth and the plurality of lower teeth includes rendering the second 3D representation on a user interface.

10. A treatment planning system, comprising:
one or more processors; and
a server system including memory storing instructions that, when executed by the one or more processors, cause the one or more processors to:
receive a first series of three-dimensional (3D) representations of an upper dental arch and a lower dental arch, the first series of 3D representations showing a progression of teeth in the upper dental arch and the lower dental arch from an initial position to a final position;
determine, for a first 3D representation of the first series of 3D representations, a distance between at least one tooth from the upper dental arch and a corresponding at least one tooth from the lower dental arch;
determine, using a transformation, a movement of at least one of the upper dental arch or the lower dental arch to decrease the distance between the at least one tooth from the upper dental arch and the corresponding at least one tooth from the lower dental arch;
generate a second 3D representation of the plurality of upper teeth and the plurality of lower teeth based on the determined movement to reflect the decreased distance; and
generate a visualization comprising the second 3D representation, the visualization depicting the progression of the teeth in the upper dental arch and the lower dental arch.

11. The treatment planning system of claim 10, wherein determining the movement of at least one of the upper dental arch or the lower dental arch includes determining a movement from a first contact position having a first occlusal contact to a second contact position having a second occlusal contact.

12. The treatment planning system of claim 10, wherein the transformation is a rigid body transformation comprising a parameterization of at least one of translational or rotational movement of at least one of the upper dental arch or the lower dental arch.

13. The treatment planning system of claim 10, wherein the instructions further cause the one or more processors to:
receive, from a treatment planning terminal, inputs for moving at least one tooth from among the plurality of upper teeth and the plurality of lower teeth relative to an occlusal axis; and
determine the distance between the at least one tooth from the upper dental arch and the corresponding at least one tooth from the lower dental arch in response to receiving the inputs for moving the at least one tooth from among the plurality of upper teeth and the plurality of lower teeth relative to the occlusal axis.

14. The treatment planning system of claim 13, wherein the inputs for moving the one or more upper teeth and the one or more lower teeth relative to the occlusal axis comprise an intrusion movement.

15. The treatment planning system of claim 13, wherein determining the distance between the at least one tooth from the upper dental arch and the corresponding at least one tooth from the lower dental arch is based on the inputs received from the treatment planning terminal.

16. The treatment planning system of claim 10, wherein the decreased distance is a minimum distance defined by a maximum contact between the plurality of teeth of the upper dental arch and the plurality of teeth of the lower dental arch.

17. The treatment planning system of claim 10, wherein the instructions further cause the one or more processors to:
determine, for the first 3D representation of the first series of 3D representations, the distance between the at least one tooth from the upper dental arch and the corresponding at least one tooth from the lower dental arch is a minimum distance; and
generate the second 3D representation of the plurality of upper teeth and the plurality of lower teeth to reflect the minimum distance.

18. The treatment planning system of claim 17, wherein the instructions further cause the one or more processors to render the second 3D representation on a user interface.

19. A non-transitory computer readable medium storing instructions that, when executed by one or more processors, cause the one or more processors to:
receive a first series of three-dimensional (3D) representations of an upper dental arch and a lower dental arch, the first series of 3D representations showing a progression of teeth in the upper dental arch and the lower dental arch from an initial position to a final position;
determine, for a first 3D representation of the first series of 3D representations, a distance between at least one tooth from the upper dental arch and a corresponding at least one tooth from the lower dental arch;
determine, using a transformation, a movement of at least one of the upper dental arch or the lower dental arch to decrease the distance between the at least one tooth from the upper dental arch and the corresponding at least one tooth from the lower dental arch;
generate a second 3D representation of the plurality of upper teeth and the plurality of lower teeth based on the determined movement to reflect the decreased distance; and
generate a visualization comprising the second 3D representation, the visualization depicting the progression of the teeth in the upper dental arch and the lower dental arch.

20. The non-transitory computer readable medium of claim 19, wherein the instructions further cause the one or more processors to render the second 3D representation on a user interface.
